(19) United States
(12) Patent Application Publication
(10) Pub. No.: US 2007/0048151 A1
(43) Pub. Date: Mar. 1, 2007

(54) Closed electric compressor

(75) Inventors: Kazuma Sakai, Ota-shi (JP); Yoshikazu Dei, Tatebayashi-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 11/511,335

(22) Filed: Aug. 29, 2006

(30) Foreign Application Priority Data
Aug. 30, 2005 (JP) 2005-249068

(51) Int. Cl. F04B 35/04; B23P 15/00

(52) U.S. Cl. 417/410.1; 29/888.02

(57) ABSTRACT

The invention has an object to reduce a manufacturing cost of a closed electric compressor for discharging a carbon dioxide refrigerant into a sealed container by manufacturing at a low cost a high pressure resistant terminal used in the compressor. In a rotary compressor as the closed electric compressor including an electrical drive element and a rotary compression mechanism section (compression element) consisting of a first and a second rotary compression element driven by the electrical drive element in a sealed container to discharge the carbon dioxide refrigerant compressed by the second rotary compression element into the sealed container, the rotary compressor has a terminal mounted on the sealed container for supplying electric power to the electrical drive element and constituted by electrical terminals and a terminal body formed by low pressure forging.

### BACKGROUND OF THE INVENTION

The present invention relates to a closed electric compressor having a terminal on a sealed container to discharge a carbon dioxide refrigerant compressed by a compression element into the sealed container.

Heretofore, this kind of closed electric compressor has been provided with an electrical drive element including a motor which is constituted of an induction machine, a DC motor and the like, and a compression element driven by the electrical drive element, in a sealed container. The closed electric compressor is operated by supplying electric power from a terminal mounted on the sealed container to the electrical drive element to drive the compression element, thereby compressing a refrigerant.

Moreover, since the terminal mounted on the sealed container uniformly receives the pressure in the sealed container, the terminal is formed into a circular shape, and a mounting portion formed along the whole circumference of a base portion of the terminal is welded on the whole circumference of a circular mounting hole formed in the sealed container to fix the terminal to the sealed container. The terminal itself is formed by pressing a steel sheet having a conventional thickness of about 1 mm to 2 mm. Electrical terminals for supplying electric power to the electrical drive element extend through the main body of the terminal, and are fixed thereto with a glass seal (e.g., refer to Japanese Patent Application Laid-Open No. 2002-266760).

Recently, in this kind of closed electric compressor, the utilization of a Fron refrigerant which has heretofore been used is prohibited owing to the problem of destruction of a global environment, and therefore a natural refrigerant such as carbon dioxide (CO₂) is being used.

Here, carbon dioxide is a refrigerant having a wide pressure range from a low pressure to a high pressure. The pressure of the carbon dioxide refrigerant discharged from the compression element will arrive at a pressure as high as 3 MPa to 10 MPa, which is much higher than in the case of the Fron refrigerant conventionally used. In consequence, the inside of the sealed container becomes a high pressure by the refrigerant discharged from the compression element. Therefore, when the conventional terminal is mounted on the sealed container, there is a problem that the terminal might be ruptured under such a high pressure.

Accordingly, in order for the terminal to withstand a high pressure of at least 40 MPa (in consideration of extraordinary pressure rise of carbon dioxide), the main body of the terminal has been made so as to have a thickness of about 5 mm to 7 mm which is thicker than a conventional terminal to increase the strength of the main body, whereby the rupture of the terminal is prevented. However, a thickness of more than 5 mm cannot be achieved by the pressing, and hence the main body of the terminal must be formed by cutting. As a result, the mass production of the terminals is difficult, which leads to a problem that a manufacturing cost remarkably increases.

### SUMMARY OF THE INVENTION

In order to solve the technical problems of the prior art described above, the present invention has been developed, and an object of the present invention is to inexpensively manufacture a high pressure resistant terminal which is used in a closed electric compressor for discharging a carbon dioxide refrigerant into a sealed container, thereby reducing a manufacturing cost of the closed electric compressor.

A first aspect of the present invention is directed to a closed electric compressor including an electrical drive element and a compression element driven by the electrical drive element in a sealed container to discharge a carbon dioxide refrigerant compressed by the compression element into the sealed container, the closed electric compressor comprising a terminal mounted on the sealed container to supply electric power to the electrical drive element, the terminal being constituted of electrical terminals and a terminal body, wherein the terminal body is formed by low pressure forging.

A second aspect of the present invention is directed to the closed electric compressor according to the first aspect, wherein the terminal body is made from a carbon steel having a carbon content of 0.18% or less, and a part only to be welded to the sealed container is machined by cutting.

According to the closed electric compressor of the first aspect of the present invention, the terminal body is formed by low pressure forging, and therefore the terminal having excellent pressure resistance can be manufactured at a low cost.

In the second aspect of the present invention, the terminal body is formed from a carbon steel having a carbon content of 0.18% or less, and a part only to be welded to the sealed container is machined by cutting. In consequence, the terminal can be fixed to the sealed container by welding without any difficulty.

As understood from the above, the terminals which is suitable for the use of the carbon dioxide refrigerant and is resistant to a high pressure can be manufactured at a low cost, so that it becomes possible to reduce a manufacturing cost of the closed electric compressor using the carbon dioxide refrigerant.

### BRIEF DESCRIPTION OF THE DRAWING

FIG. 1 is a longitudinal-sectional side view of a rotary compressor of one embodiment of the invention.

### DETAILED DESCRIPTION OF THE PREFERRED EMBODIMENT

The present invention is characterized by inexpensively manufacturing a terminal usable in a high internal pressure type closed electric compressor for discharging a carbon dioxide refrigerant compressed by a compression element into a sealed container, to reduce a manufacturing cost of the closed electric compressor. In other words, the object to manufacture a high pressure resistant terminal at a low cost is achieved by making the terminal body by low pressure forgoing. The embodiment of the invention will be explained in detail with reference to the drawing hereinafter.

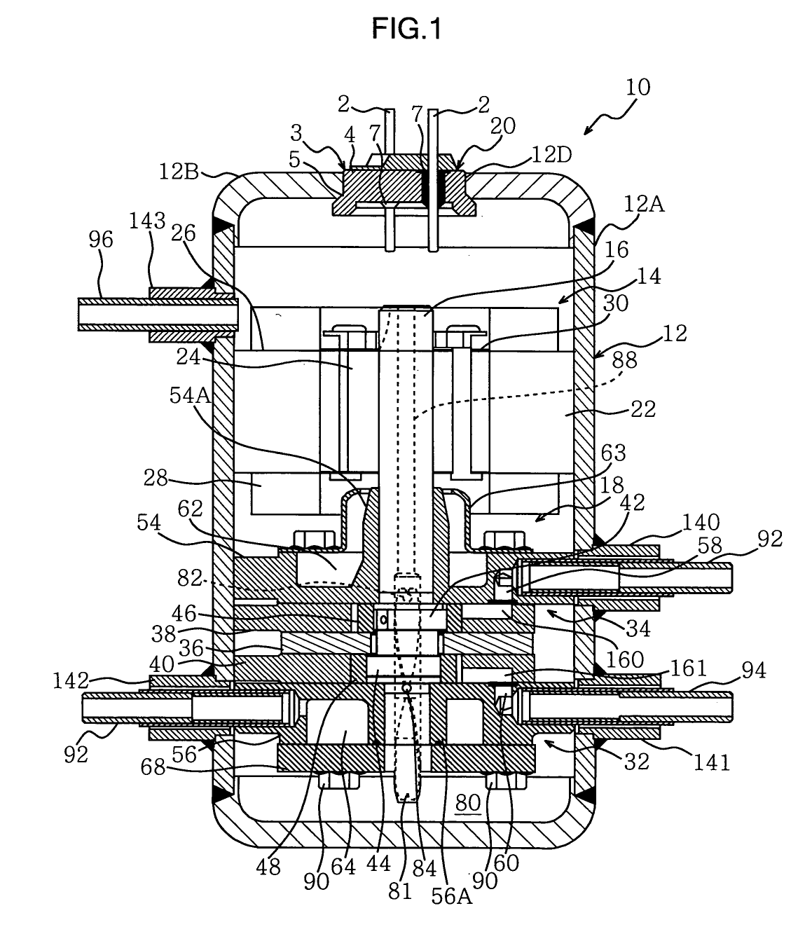

FIG. 1 is a longitudinal-sectional side view illustrating a rotary compressor 10 as one embodiment of the closed electric compressor according to the invention having in a sealed container 12 an electrical drive element 14 and a rotary compression mechanism section 18 as a compression element driven by the electrical drive element 14.

In FIG. 1, the rotary compressor 10 of the illustrated embodiment includes the rotary compression mechanism section 18 consisting of a first rotary compression element 32 and a second rotary compression element 34. In the high internal pressure type rotary compressor, a refrigerant compressed by the first rotary compression element 32 is sucked into the second rotary compression element 34, and the refrigerant further compressed at a high temperature and high pressure by the second rotary compression element 34 is discharged into the sealed container 12. Carbon dioxide (CO₂) is used as the refrigerant for the rotary compressor 10 of the embodiment.

The sealed container 12 includes a vertically elongated cylindrical container body 12A and a substantially bowl-shaped end cap (cover) 12B for closing the upper end opening of the container body 12A. The sealed container accommodates the rotary compression mechanism section 18 in its lower section and the electrical drive element 14 in its upper section. There is provided an oil reservoir 80 at the bottom in the container body 12A of the sealed container 12.

The end cap 12B of the sealed container 12 is formed in its upper surface with a circular mounting hole 12D for mounting a terminal for supplying electric power to the electrical drive element 14 (wiring is not shown in the drawing). The terminal 20 consists of a plurality of electrical terminals 2 for supplying electric power to the electrical drive element 14 and a terminal body 3. The terminal body 3 consists of a circular base portion 4 and a mounting portion 5 spreading and extending from the circumference of the base portion 4 outwardly and downwardly (toward the inside of the sealed container 12). The base portion 4 of the terminal body 3 is 5 mm to 7 mm in thickness, so that its strength is greater than that of at least the end cap 12B. The base portion 4 is provided with electrical terminals 2 passing through the base portion 4 and fixed thereto with a glass seal 7. A method for manufacturing the terminal 20 will be described in detail later.

The electrical drive element 14 includes a stator 22 annularly welded and fixed to the inner circumferential surface in the upper space of the sealed container 12 and a rotor 24 inserted and installed in the inside of the stator 22 with some clearance. The rotor 24 is fixed to a rotary shaft 16 located at the center of the container and vertically extending.

The stator 22 includes a laminated body 26 formed by laminating doughnut-shaped magnetic steel sheets, and stator coils 28 wound about toothed portions of the laminated body 26 in a series coil (concentrated winding) system. Moreover, the rotor 24 is also formed of a laminated body 30 of magnetic steel sheets similarly to the stator 22.

The rotary compression mechanism section 18 includes the second rotary compression element 34 as a second compression stage on the side of the electrical drive element 14 in the sealed container 12 with respect to an intermediate partition plate 36, and the first rotary compression element 32 as a first compression stage on the opposite side from the electrical drive element 14 with respect to the intermediate partition plate 36. In other words, the first rotary compression element 32 and the second rotary compression element 34 are arranged on the upper and lower sides of the intermediate partition plate 36, respectively, and include rollers 46 and 48 fitted in upper and lower eccentric portions 42 and 44 which are formed in upper and lower cylinders 38 and 40 constituting the first and second rotary compression elements 32 and 34, respectively, and are also formed in the rotary shaft 16 of the electrical drive element 14 so that the rollers 46 and 48 are eccentrically rotated in the respective cylinders 38 and 40, vanes (not shown) abutting against the rollers 46 and 48 to partition the insides of the cylinders 38 and 40 into high pressure chamber sides and low pressure chamber sides, respectively, a lower support member 56 adapted to close one (lower) opening of the lower cylinder 40 and having a bearing 56A for the rotary shaft 16, and an upper support member 54 adapted to close an upper opening of the upper cylinder 38 and having a bearing 54A for the rotary shaft 16. The upper and lower eccentric portions 42 and 44 are provided on the rotating shaft 16 with a phase difference of 180°.

The upper support member 54 and the lower support member 56 include suction passages 58 and 60 adapted to communicate through suction ports 160 and 161 with the insides of the upper and lower cylinders 38 and 40, respectively, and a discharge silencer chamber 62 formed by recessing the upper surface of the upper support member 54 on the opposite side from the upper cylinder 58 and by closing the recess thus formed by an upper cover 63, and a discharge silencer chamber 64 formed by recessing the lower surface of the lower support member 56 on the opposite side from the lower cylinder 40 and by closing the recess thus formed by a lower cover 68, respectively. Namely, the discharge silencer chambers 62 and 64 are closed by the upper cover 63 and the lower cover 68, respectively. In this case, the upper support member 54 is formed at the middle with a bearing 54A standing upright, and similarly the lower support member 56 is formed at the middle with a bearing 56A extending therethrough.

Moreover, the lower cover 68 is formed from a doughnut-shaped circular steel plate and fixed to the lower support member 56 at four locations in the periphery portion by four bolts from below, thereby closing the opening lower surface of the discharge silencer chamber 64 communicating through a discharge port (not shown) with the inside of the lower cylinder 40 of the first rotary compression element 32. Tips of the bolts 90 are screwed into the upper support member 54.

The upper cover 63 is formed with a communication passage (not shown) which causes the discharge silencer chamber 62 to communicate with the inside of the sealed container 12, thereby discharging the refrigerant gas at a high temperature and high pressure compressed by the second rotary compression element 34 through the communication passage (not shown) into the sealed container 12.

On the one hand, mounted on the one end (lower end) of the rotary shaft 16 is an oil pump 81 as oil supply means for sucking up the oil accumulated in the oil reservoir 80. The oil pumped by the oil pump 81 is supplied to sliding portions of the rotary compression mechanism section 18 and the like through an oil hole 88 vertically formed along the center axis of the rotary shaft 16 and lateral oil supply holes 82 and 84 (also formed in the upper and lower eccentric portions 42 and 44) communicating with the oil hole 88.

In the rotary compressor 10 in the illustrated embodiment, furthermore, carbon dioxide as a refrigerant is used which is a natural refrigerant and good for environment. Examples of oils which can be used as lubricating oils include existent oils such as mineral oils, PAG (polyalkylene glycol), alkylbenzene oil, ether oil, and ester oil.

On the other hand, the side face 12A of the sealed container 12 is provided with sleeves 140, 141, 142 and 143 fixed thereat by welding at locations corresponding to the suction passages 58 and 60 of the upper and lower support members 54 and 56, the discharge silencer chamber 64 and an upper portion of the electrical drive element 14. The sleeves 140 and 141 are adjacent to each other one above the other, and the sleeves 142 and 141 are substantially on a diagonal line.

Inserted into and connected to the sleeve 140 is one end of a refrigerant inlet pipe 92 for conducting the refrigerant gas into the upper cylinder 38, and the end of the refrigerant inlet pipe 92 communicates with the suction passage 58 of the upper cylinder 38. The refrigerant inlet pipe 92 extends over the sealed container 12 to the sleeve 142, and the other end of the refrigerant inlet pipe 92 is inserted into and connected to the sleeve 142 so as to communicate with the discharge silencer chamber 64.

Moreover, inserted into and connected to the sleeve 141 is one end of a refrigerant inlet pipe 94 for conducting the refrigerant gas into the lower cylinder 40, and the one end of a refrigerant inlet pipe 94 communicates with the suction passage 60 of the lower cylinder 40. Further, a refrigerant discharge pipe 96 is inserted into and connected to the sleeve 143, and one end of the refrigerant discharge pipe 96 communicates with the inside of the sealed container 12.

The operation of the rotary compressor thus constructed will be explained. When the stator coils 28 of the electrical drive element 14 are energized through the electrical terminals 2 of the terminal 20 and wirings (not shown), the electrical drive element 14 is started to rotate the rotor 24. Upon rotation of the rotor 24, the rollers 46 and 48 fitted in the upper and lower eccentric portions 42 and 44 integrally formed with the rotary shaft 16 are eccentrically rotated in the upper and lower cylinders 38 and 40, respectively.

Herewith, the refrigerant gas under a lower pressure, which has been sucked through the refrigerant inlet pipe 94 and the suction passage 60 formed in the lower support member 56 via the suction port 161 into the low pressure chamber side of the lower cylinder 40, is compressed by the action of the roller 48 and the vane (not shown) to be under an intermediate pressure, and is discharged from the high pressure chamber side of the lower cylinder 40 through a discharge port (not shown) into the discharge silencer chamber 64.

The refrigerant gas under an intermediate pressure discharged into the discharge silencer chamber 64 is sucked through the refrigerant inlet pipe 92 communicating with the discharge silencer chamber 64 and through the suction passage 58 formed in the upper support member 54 via the suction port 160 into the low pressure chamber side of the upper cylinder 38.

The refrigerant gas under the intermediate pressure sucked into the upper cylinder 38 is compressed as compression of a second stage by the action of the roller 46 and the vane (not shown) to be the refrigerant at a high temperature and high pressure, which is then discharged from the high pressure chamber side of the upper cylinder 38 through a discharge port (not shown) into the discharge silencer chamber 62 formed in the upper support member 54.

Then, after the refrigerant discharged into the discharge silencer chamber 62 has been discharged through a communication passage (not shown) into the sealed container 12, the refrigerant moves through clearances of the electrical drive element 14 to the upper portion of the sealed container 12 and is discharged through the refrigerant discharge pipe 96 connected to the upper portion of the sealed chamber 12 into the outside of the rotary compressor 10.

In this way, the inside of the sealed container 12 of the rotary compressor 10 is under a high pressure which is much higher than that of the hitherto used Fron refrigerant. Therefore, the strength of the terminal has been noticed. In the case of the hitherto used Fron refrigerant, a main body of a terminal having a thickness of the order of 1 mm to 2 mm can sufficiently tolerate the pressure of the refrigerant discharged into a sealed container 12 so that the terminal body could be formed by press-working from a steel sheet.

On the other hand, the carbon dioxide (CO₂) refrigerant becomes a very high pressure by compression as compared with a conventional refrigerant, so that the main body of a conventional terminal may be outwardly deformed or inflated, and the glass seal 7 and electrical terminals 2 may be blown off. In the case using carbon dioxide as a refrigerant, it becomes necessary to use a terminal to withstand at least a pressure of more than 40 MPa in consideration of the extraordinary pressure rise of the carbon dioxide refrigerant. In this case, the terminal body must be formed to be thicker (on the order of 5 mm to 7 mm in thickness) than that of prior art. Since it is impossible to form such a thicker product by the conventional press-working, the whole terminal body was formed by machining or cutting working.

Consequently, mass production of the terminal would become difficult and a manufacturing cost would go up, so that the closed electric compressor using carbon dioxide as a refrigerant has been of an expensive specification.

According to the invention, consequently, a terminal body 3 is made by low pressure forging to form a terminal 20. Moreover, the terminal body 3 is formed from a carbon steel which is S15C (Japanese Industrial Standard) of carbon content of 0.18% or less, and after formed by the low pressure forging, the mounting portions 5 only are worked by machining or cutting which are to be fixed to the end cap 12B of the sealed container 12 by projection welding.

In this way, after the entire terminal body 3 has been formed by low pressure forging, the mounting portions 5 only which are required to be with high accuracy are machined or cut to obtain the finished portions with accurate dimensions, whereby it becomes possible to manufacture the high pressure resistant terminal 20 with high accuracy. As understood from the above, the terminal can inexpensively be manufactured as compared with a terminal made by cutting the whole terminal body in the prior art. As described above, the terminal body 3 of the illustrated embodiment is made from S15C in which a carbon content is 0.18% or less. The S15C is a carbon steel having a carbon content of 0.15% or 0.13% to 0.18%. By using such a comparatively mild or soft carbon steel of carbon content of 0.18% or less in this manner, the terminal body 3 can be easily formed by low pressure forging. Although S15C is used as a material for the terminal body 3 in the illustrated embodiment, it is to be understood that carbon steels having a carbon content of 0.18% or less other than S15C may be used, such as S12C, S10C (Japanese Industrial Standard) and the like as concrete examples. These carbon steels are all comparatively soft and can be easily molded by low pressure forging.

As described above in detail, the present invention enables the mass production of the terminals 20 suitable for the use of a carbon dioxide refrigerant and resistant to a high pressure, and also enables the reduction of a manufacturing cost of the rotary compressor 10 using carbon dioxide as a refrigerant.

Moreover, in order to mount the terminal 20 onto the sealed container 12, the terminal body 3 is first inserted into the mounting hole 12D from the inner side of the sealed container 12 of the end cap 12B, so that the mounting portion 5 of the terminal body 3 abuts on the periphery of the mounting hole 12D. In this condition, the whole circumference of the abutment portion is subjected to projection welding, whereby the mounting portion 5 can be fixed to the end cap 12B round the periphery of the mounting hole 12D.

While the embodiment is described with the multistage compression rotary compressor 10 having a vertical rotary shaft 16, it will be apparent that the invention may be applicable to a closed electric compressor having a horizontal rotary shaft. Moreover, not limited to the rotary compressors, the invention is also applicable to a scroll type closed electric compressor and the like, insofar as they include an electrical drive element and a compression element driven by the electrical drive element in a sealed container and are adapted to discharge a carbon dioxide refrigerant into the sealed container.

Moreover, the invention is also applicable to a closed electric compressor having three, four or more stages of compression elements without any objection. Adversely, the invention is still effective to apply to a closed electric compressor having a single compression element.

What is claimed is:

1. A closed electric compressor including an electrical drive element and a compression element driven by the electrical drive element in a sealed container to discharge a carbon dioxide refrigerant compressed by the compression element into the sealed container, the closed electric compressor comprising:
a terminal mounted on the sealed container to supply electric power to the electrical drive element,
the terminal being constituted of electrical terminals and a terminal body, wherein the terminal body is formed by low pressure forging.

2. The closed electric compressor according to claim 1, wherein the terminal body is made from a carbon steel having a carbon content of 0.18% or less, and a part only to be welded to the sealed container is machined by cutting.
